(19) United States
(12) Patent Application Publication
(10) Pub. No.: US 2020/0055448 A1
(43) Pub. Date: Feb. 20, 2020

(54) ILLUMINATED VEHICLE HEADREST

(71) Applicant: WINDSOR MACHINE AND STAMPING (2009) LTD., Windsor, CA (US)

(72) Inventor: David James Hunt, Kingsville (CA)

(21) Appl. No.: 16/545,648

(22) Filed: Aug. 20, 2019

Related U.S. Application Data
(60) Provisional application No. 62/719,895, filed on Aug. 20, 2018.

(51) Int. Cl. B60Q 3/233; B60N 2/879; B60N 2/809; B60Q 3/80; B60Q 3/70; H05B 33/08

(52) U.S. Cl. CPC B60Q 3/233; B60N 2/879; B60N 2/809; H05B 33/0857; B60Q 3/70; H05B 33/0845; B60Q 3/80

(57) ABSTRACT

A vehicle headrest assembly including a light source for illuminating an occupant's space. The vehicle headrest assembly includes a housing operatively coupleable to a vehicle seatback and a cover at least partially surrounding the housing. At least a portion of the housing is constructed of translucent or transparent material allowing the light source to illuminate therethrough. The light source may be an LED or an electroluminescent material. Several headrest assemblies may be incorporated into a rideshare vehicle or public transport vehicle to provide indicators to passengers of assigned seating and notify passengers that they have arrived at their destination. The illumination from the headrest assembly may further be personalized by an occupant or driver by changing the color, brightness, and other settings.

### CROSS-REFERENCE TO RELATED APPLICATION

This U.S. Patent Application claims the benefit of and priority to U.S. Provisional Patent Application Ser. No. 62/719,895, filed on Aug. 20, 2018, titled “Illuminated Vehicle Headrest,” the entire disclosure of which is hereby incorporated by reference.

### BACKGROUND OF THE INVENTION

### 1. Field of the Invention

The present invention relates to vehicle headrests and, more particularly, to an illuminated headrest assembly for vehicles.

### 2. Related Art

This section provides background information related to the present disclosure which is not necessarily prior art.

Technological improvements of vehicles have generally been focused on enhancements to features including efficiency, safety, and comfort. In a race to improve these features, matters of technological conveniences are often overlooked. These technological conveniences not only make an occupant's travel experience more enjoyable, they tangentially result in improvements to efficiency, safety, and comfort. More specifically, a more enjoyable travel experience results in longer periods of driving between stops and can also encourage less movement of occupants during travel, particularly children.

One example feature of a vehicle that has historically been employed only for safety and comfort is a headrest. Most vehicles include headrests atop an occupant's seat and in a position adjacent the occupant's head. Headrests are typically cushioned for comfort and most are commonly finished in the same material as the rest of the seat. For the most part, a headrest is not shared among occupants and can be adjusted in one or more positions for a specific body size and comfort preference. Because accommodating user preferences have historically been limited to adjusting the position of the headrest, there is a continuing desire to provide additional functionality to the headrest and provide an occupant more options to improve and personalize their travel experience.

### SUMMARY OF THE INVENTION

This section provides a general summary of the disclosure and is not to be interpreted as a complete and comprehensive listing of all of the objects, aspects, features and advantages associated with the present disclosure.

According to one aspect of the disclosure, a vehicle headrest assembly for a vehicle is provided. The vehicle headrest assembly comprises a housing operatively coupleable to a vehicle seatback. A cover at least partially surrounds the housing and a light source is at least partially located within at least one of the housing and the cover.

According to another aspect of the disclosure, a vehicle including a plurality of seats that each include a headrest assembly is provided. Each of the headrest assemblies comprise a housing operatively coupleable to a vehicle seatback, a cover at least partially surrounding the housing, and a light source at least partially located within at least one of the housing and the cover.

According to yet another aspect of the disclosure, a method of directing a passenger to one of a plurality of passenger seats each having a headrest assembly in a rideshare vehicle is provided. The method includes obtaining a pick-up request from a passenger, determining the availability of the plurality of passenger seats, and assigning one of the plurality of passenger seats according to availability. The method continues by illuminating the headrest assembly of the assigned seat and notifying the passenger of the illuminated headrest assembly associated with the passenger's assigned seat. The illuminated headrest assembly is turned off once the passenger is seated in the assigned seat.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of an illuminated headrest assembly;

FIG. 2 is a perspective view of internal components of the illuminated headrest assembly according to another aspect of the disclosure;

FIG. 3 is a schematic view of a RGB assembly circuit used in conjunction with the illuminated headrest assembly shown in FIG. 2;

FIG. 4 is a schematic view of one example application of the illuminated headrest assembly guiding a passenger in a rideshare vehicle; and

FIG. 5 is a method flow chart including steps in accordance with the application shown in FIG. 4.

### DESCRIPTION OF THE ENABLING EMBODIMENT

Example embodiments will now be described more fully with reference to the accompanying drawings. In general, the subject embodiments are directed to an illuminated headrest assembly for vehicles. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the headrest assembly is intended for providing an enhanced travel experience to occupants of a vehicle via incorporation of lights into the headrest assembly.

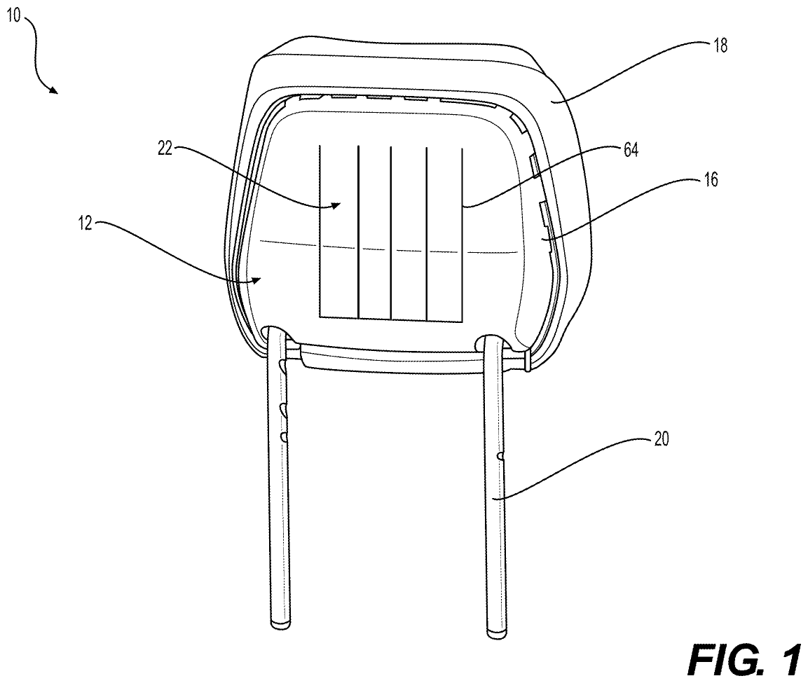

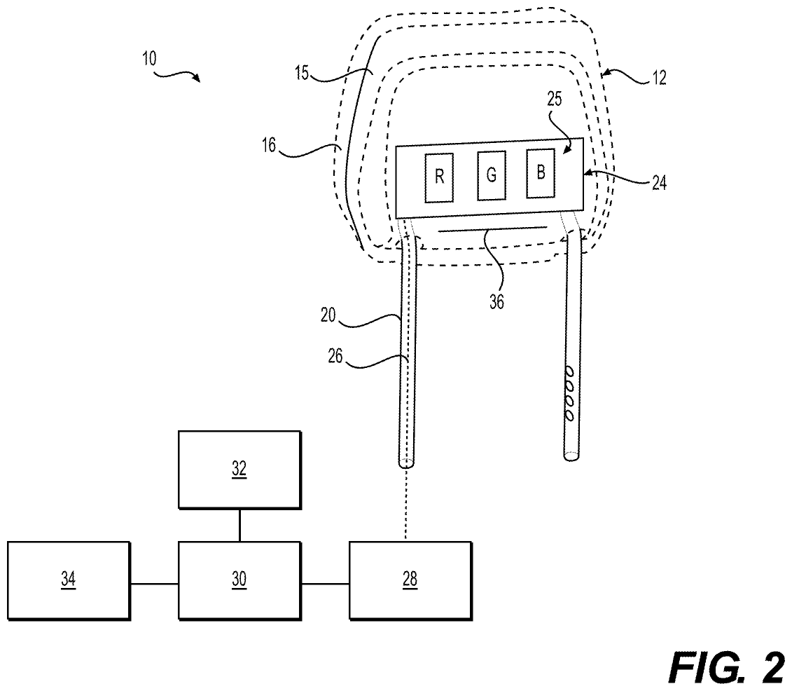

With initial reference to FIG. 1, a headrest assembly is depicted. The headrest assembly is generally referred to with numeral 10. The headrest assembly 10 includes a housing 12 that at least partially encloses several components associated with stabilization and/or adjustment of the headrest assembly. The housing 12 includes a front shell 15 (FIG. 2) and a rear shell 16 that are operatively coupled to each other in some embodiments. Alternatively, it is contemplated that a single, unitary housing 12 is provided. A cover 18 is provided over the housing 12 for aesthetic purposes and occupant comfort. A portion of the cover 18 is removed in the illustrated embodiment in FIG. 1 to show a portion of the housing 12. The housing 12 is operatively coupleable to a vehicle seatback, such that it can be one integral piece or adjustable. For example, the headrest assembly 10 may include a base portion 20 (which may also be referred to as an “armature”) that is mountable to a vehicle seat (not shown) and, more specifically, to the upper portion of the seatback of the vehicle seat.

The embodiments of the headrest assembly 10 disclosed herein include at least one illuminated portion 22. In particular, the illuminated portion 22 may be one or more surfaces of the headrest assembly 10 or the entire headrest assembly 10. In some embodiments, the illumination is provided by the housing 12 being formed of a translucent material or any other material configured to be illuminated in a controlled manner. For example, the front shell 15 and/or rear shell 16 may be illuminated. Alternatively, it is contemplated that the cover 18 may be the material that is the source of the illumination and/or may also be translucent.

Regardless of which portions of the headrest assembly 10 are illuminated and regardless of the source of illumination, the illuminated portion 22 is visible from the exterior of the cover 18 via a translucent cover or by an absence of the cover 18 over the illuminated portion 22. For example, the cover may include an aperture or a translucent portion superimposed over the illuminated portion 22. The visible illuminated portion 22 may be controlled to be different colors in some embodiments or may be limited to a single color. This may be desirable for lighting preferences in the interior of a vehicle. As such, a vehicle operator or passenger is able to control whether the light is on and/or what color is illuminated.

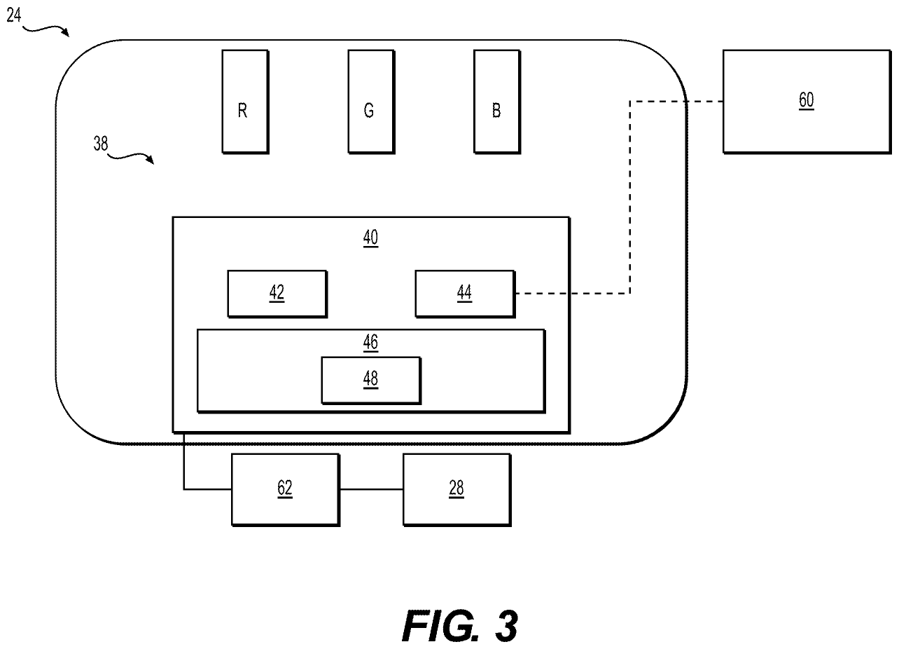

FIG. 2 illustrates another embodiment where a light source includes at least one LED light disposed within the housing 12, but a series of LED lights are disposed within the housing 12 in some embodiments. As shown, the series of LED lights includes a red LED, a green LED, and a blue LED, collectively resulting in “RGB LED” 25. By mixing the magnitude of each color, the RGB LED 25 can produce a large range of colors for personalized preferences. The RGB LED 25 may be contained within an envelope 24 that is embedded within the headrest assembly 10. The envelope 24 encloses and protects the various components (FIG. 3) associated with the RGB LED 25. The envelope 24 can be constructed of hard plastic, a semi-flexible material that allows some deformability, or a flexible material, so long as the material is translucent or transparent. The envelope 24 can be directly connected to the armature 20 and may also be water resistant. A power cable 26 may extend from the envelope 24, through the armature 20, to a power source 28. It should be appreciated, however, that the power source 28 may alternatively be located within the housing 12. In some arrangements, the power source 28 is a battery and, more specifically, a rechargeable battery that is connected to and charged by a vehicular electrical system 30. The vehicular electrical system 30, may include one or more of a vehicle alternator 32 or a power generation system 34 such as a regenerative braking. In order to assist in the maintenance of the RBG LED 25 and associated components, an access opening 36 may be provided within the housing 12.

FIG. 3 is a schematic view of the RGB LED 25 and an associated RGB LED assembly circuit 38 contained within envelope 24. The various elements provided therein allow for a specific implementation. Thus, one of ordinary skill in the art of electronics and circuits may substitute various components to achieve a similar functionality. The RGB LED assembly circuit 38 may include a microcontroller 40 that controls certain features and settings of the RGB LED 25 such as regulating voltage from the power source 28, increasing brightness, and changing colors. The microcontroller 40 includes a microprocessor 42, a communications module 44, and a memory 46 having machine readable non-transitory storage. Programs and/or software 48 are saved on the memory 46. The microprocessor 42 carries out instructions based on the software 48, for example, changing colors at predetermined time intervals. Software 48 may be updated via the transmission of information between the communications module 44 and one or more computing devices 60. For example, the computing device 60 may be a mobile device such as mobile phone, tablet, laptop or wearable technology. Alternatively, turning on, color choice, brightness, and other additional settings of the RGB LED 25 may be controlled via a local user interface 62 that includes a plurality of buttons. For example, the user interface 62 may be located on the cover 18 of the headrest assembly 10, the seat associated with the headrest assembly 10, or any other in-cabin user interface, thereby allowing an occupant to select various features such as on/off, color changing, and brightness.

It should be appreciated that while the RGB LED 25 is provided as one example of illumination, it should be appreciated that the headrest assembly 10 may incorporate other sources of illumination. For a non-limiting example, portions of the front shell 15, the rear shell 16, and/or the cover 12 may comprise electroluminescent material. The electroluminescent material may be integrated with electrodes 64 (FIG. 1) for providing current and illuminating the electroluminescent material.

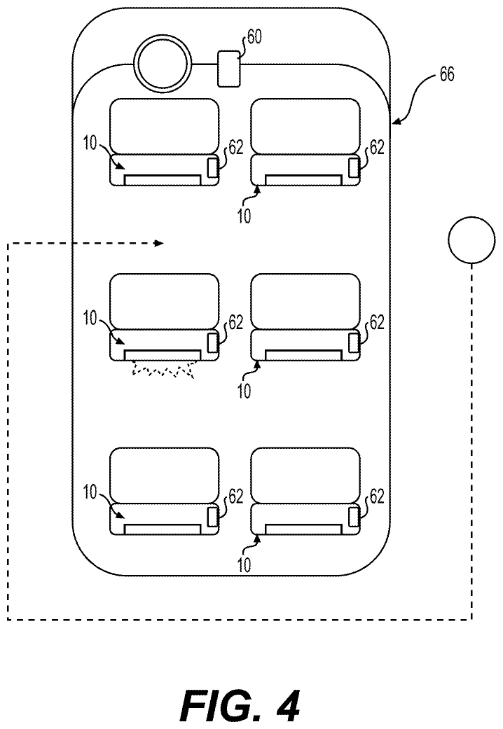

In addition to facilitating lighting choices, it is noted that ride sharing is an increasingly popular carpooling option that includes one or more individuals sharing a vehicle to be transported. As shown in FIG. 4, the headrest assembly 10 disclosed herein may provide additional efficiency to rideshare vehicles and/or public transport 66, including transport networking company vehicles. For example, the headrest assembly 10 may provide vehicle passengers with an indicator related to which seat they have been assigned to and/or may also provide an indication once the rideshare vehicle 66 has arrived at a specific location. For example, upon requesting a vehicle, such as via a mobile app, a color-coded seat assignment is provided to the user based on which seat they would be most efficiently or comfortably seated in. The order of pick-ups and drop-offs and the side of the vehicle on which the passengers will be picked-up may influence the most efficient seating assignments and the lighting provides a clear indicator of seating assignment. It is noted that there is a headrest assembly 10 located on the driver's seat. It should be appreciated that the illuminated portion of the headrest assembly 10 may be located to illuminate the seat behind the headrest assembly. As such, the local user interface 62 may control settings of the headrest assembly 10 in a seat forward of the occupant. Alternatively, the illuminated portion may be located to illuminate forward such that the local user interface 62 controls settings of the headrest assembly 10 associated with that seat.

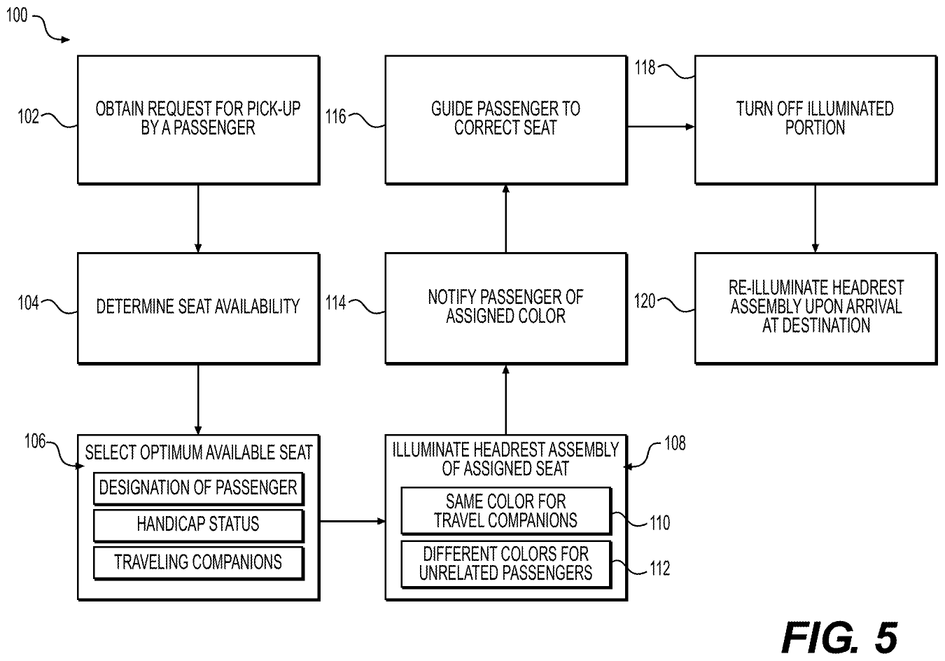

A method flowchart of steps associated with the rideshare application is presented in FIG. 5. The method 100 includes a rideshare vehicle driver obtaining a request for pick-up 102 by a passenger. The method 100 continues by determining if and which seat is available 104 to the passenger. The step of determining if and which seat is available 104 may include selecting an optimum seat based on at least one factor 106. The at least one factor can include a requested destination of the passenger, a handicap status of the passenger, and if more than one passenger is traveling together. To guide a passenger, a headrest assembly with at least one illuminable portion that is associated with the available seat is illuminated 108. The step 108 may include illuminating the headrest assembly on the available seat or in the seat forward of the available seat. In instances where the rideshare vehicle driver obtains a request for multiple passengers, some passengers that are traveling together and others that are not, multiple seats may be illuminated with one color 110 associated with the group of passengers traveling together to ensure they are able to travel together. In addition, the seats for the other passengers may be illuminated with a different color 112. Next, the passengers may be notified of which color they are assigned to 114. The step 114 may be a verbal confirmation by the driver or it may be sent directly to a passenger's mobile device. Next, the passenger is picked up and guided by the illuminated portion 116. After the passenger has reached their seat, the illumination may be turned off 118. Once the rideshare vehicle arrives at a given destination, the illuminable portion may be illuminated again 120 to indicate to the passenger that they have arrived at their destination.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle headrest assembly for a vehicle comprising:
a housing operatively coupleable to a vehicle seatback;
a cover at least partially surrounding the housing; and
a light source at least partially located within at least one of the housing and the cover.

2. The vehicle headrest assembly of claim 1, wherein the light source includes an RGB LED.

3. The vehicle headrest assembly of claim 2, wherein the RGB LED is located within the housing.

4. The vehicle headrest assembly of claim 3, wherein the housing includes a housing portion comprising material that allows light to be transmitted therethrough.

5. The vehicle headrest assembly of claim 4, wherein the cover includes a cover portion superimposed over the housing portion and the cover portion comprises material that is translucent.

6. The vehicle headrest assembly of claim 4, wherein the cover includes a cover aperture superimposed over the housing portion such that it does not obstruct the transmission of light.

7. The vehicle headrest assembly of claim 1, further comprising an armature operatively coupling the housing to the vehicle seatback and permitting the housing to move vertically with respect to the vehicle seatback.

8. The vehicle headrest assembly of claim 7, further comprising a power source and a power cable, the power cable extending from the light source to the power source.

9. The vehicle headrest assembly of claim 8, wherein the power cable extends through the armature to the power source and the power source is located outside of the housing.

10. The vehicle headrest assembly of claim 1, further comprising an RGB LED assembly circuit including a microcontroller and microprocessor.

11. The vehicle headrest assembly of claim 10, wherein the microprocessor is configured to receive instructions from a remote computing device to change at least one setting of the RGB LED.

12. The vehicle headrest assembly of claim 11, wherein the at least one setting includes turning the RGB LED on and off.

13. The vehicle headrest assembly of claim 12, wherein the at least one setting includes an additional setting to change the color of light transmitted by the RGB LED.

14. The vehicle headrest assembly of claim 10, further comprising an envelope for protecting the RGB LED assembly circuit, wherein the RGB LED assembly circuit is enclosed within the envelope.

15. The vehicle headrest assembly of claim 1, wherein the light source includes an electroluminescent material.

16. The vehicle headrest assembly of claim 15, wherein the electroluminescent material forms part of the housing.

17. A vehicle including a plurality of seats that each include a headrest assembly, each of the headrest assemblies comprising:
a housing operatively coupleable to a vehicle seatback;
a cover at least partially surrounding the housing; and
a light source at least partially located within at least one of the housing and the cover.

18. A method of directing a passenger to one of a plurality of passenger seats each having a headrest assembly in a rideshare vehicle comprising the steps of:
obtaining a pick-up request from a passenger;
determining the availability of the plurality of passenger seats;
assigning one of the plurality of passenger seats according to availability;
illuminating the headrest assembly of the assigned seat;
notifying the passenger of the illuminated headrest assembly associated with the passenger's assigned seat; and
turning off the illuminated headrest assembly once the passenger is seated in the assigned seat.
